(19) United States
(12) Patent Application Publication
(10) Pub. No.: US 2023/0367873 A1
(43) Pub. Date: Nov. 16, 2023

(54) INFORMATION PROCESSING APPARATUS AND CONTROL METHOD OF INFORMATION PROCESSING APPARATUS

(71) Applicant: CANON KABUSHIKI KAISHA, Tokyo (JP)

(72) Inventor: NOBUYASU ITO, Chiba (JP)

(21) Appl. No.: 18/298,959

(22) Filed: Apr. 11, 2023

(30) Foreign Application Priority Data
May 13, 2022 (JP) 2022-079312

(51) Int. Cl. G06F 21/55; G06F 11/14; G06F 21/57

(52) U.S. Cl. CPC G06F 21/554; G06F 11/1415; G06F 21/575; G06F 2221/033; G06F 2201/865

(57) ABSTRACT

An information processing apparatus including a first storage unit storing a program and a second storage unit storing a backup program of the program includes a verification unit configured to verify tampering of the program stored in the first storage unit, a recovery unit configured to perform recovery by overwriting the backup program stored in the second storage unit with the program stored in the first storage unit in a case where the program is tampered, and a power control unit configured to stop power to the verification unit and the second storage unit upon termination of the verification by the verification unit in a case where the program is not tampered, and stop power to the verification unit and the second storage unit upon termination of the verification by the verification unit and termination of the recovery by the recovery unit in a case where the program is tampered.

### BACKGROUND

### Field of the Invention

The present disclosure relates to an information processing apparatus configured to control power of a circuit for detecting tampering of firmware in the information processing apparatus, and a control method of the information processing apparatus.

### Description of the Related Art

In order to provide security measures, a conventional information processing apparatus is provided with a circuit that detects tampering for a basic input output system (BIOS) of a main central processing unit (CPU) used in a control unit of an image forming apparatus.

Japanese Patent Application Laid-Open No. 2013-114620 discusses that validation is performed on a program to be executed by a main CPU at activation of an information processing apparatus, and in a case where validity is not confirmed, a certain unit that is different from the main CPU gives a notification of abnormality. Japanese Patent Application Laid-Open No. 2021-72060 discusses that an activation time is shortened by performing validation on a program when an information processing apparatus is turned off.

### SUMMARY

According to an aspect of the present disclosure, an information processing apparatus including a first storage unit storing a program and a second storage unit storing a backup program of the program includes a verification unit configured to verify tampering of the program stored in the first storage unit, a recovery unit configured to perform recovery by overwriting the backup program stored in the second storage unit with the program stored in the first storage unit in a case where the program is tampered as a result of verification by the verification unit, and a power control unit configured to stop power to the verification unit and the second storage unit upon termination of the verification by the verification unit in a case where the program is not tampered, and stop power to the verification unit and the second storage unit upon termination of the verification by the verification unit and termination of the recovery by the recovery unit in a case where the program is tampered.

Further features of the present disclosure will become apparent from the following description of exemplary embodiments with reference to the attached drawings.

### BRIEF DESCRIPTION OF THE DRAWINGS

FIG. 1A illustrates a configuration of an image forming apparatus.

FIG. 1B illustrates a configuration of the image forming apparatus in a sleep state.

FIG. 2 illustrates a configuration of a main central processing unit (CPU).

FIG. 3 illustrates a configuration of a sub CPU.

FIG. 4 illustrates a memory map of a flash (registered tradename) read only memory (ROM).

FIG. 5A illustrates a power supply configuration.

FIG. 5B illustrates the power supply configuration.

FIG. 6 illustrates a configuration of a printer unit.

FIG. 7A is a flowchart illustrating maintenance processing of a printer engine.

FIG. 7B is a flowchart illustrating the maintenance processing of the printer engine.

FIG. 8 is a timing chart illustrating power supply control during the maintenance processing of the printer engine.

FIG. 9 illustrates a configuration of a network interface (I/F).

FIG. 10A is a flowchart illustrating Wake on Lan (WOL) packet processing using the network I/F.

FIG. 10B is a flowchart illustrating the WOL packet processing using the network I/F.

FIG. 11 is a timing chart illustrating power supply control during the WOL packet processing using the network I/F.

### DESCRIPTION OF THE EMBODIMENTS

A method for decreasing power of a tampering verification circuit according to a first exemplary embodiment of the present disclosure is to be described. Components described in the present exemplary embodiment are merely examples, and the scope of the present disclosure is not limited only to these components. Unless otherwise specified, the present disclosure is obviously applicable to single device or a system including a plurality of devices as long as a function of the present disclosure is carried out.

The present disclosure is not limited to an image forming apparatus, and may be applicable to any information processing apparatus that is operated by executing firmware. The present disclosure is particularly applicable also to devices connected to a network, such as a smartphone, a camera, and a smart watch.

### Hardware Configuration of Image Forming Apparatus

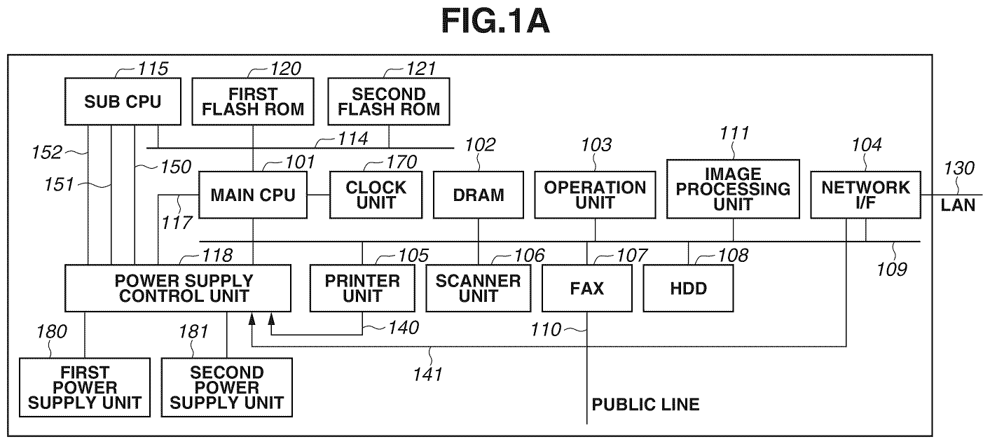

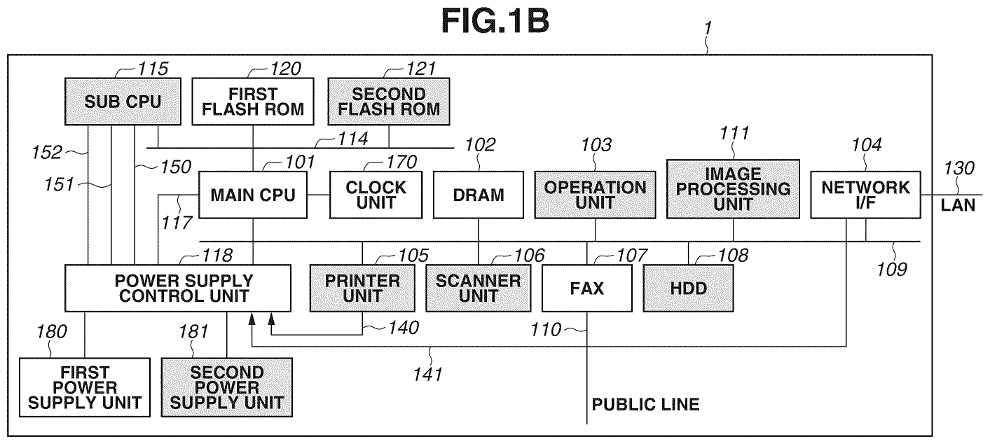

FIG. 1A illustrates a configuration of an image forming apparatus 1, which is an information processing apparatus.

A main central processing unit (CPU) 101 entirely controls the image forming apparatus 1.

A dynamic random access memory (DRAM) 102 stores a program to be executed by the main CPU 101, and functions as a temporary work area for data.

An operation unit 103 notifies the main CPU 101 of an operation performed by a user.

A network interface (I/F) 104 is connected with a local area network (LAN) 130 to communicate with an external device.

A printer unit 105 prints image data on paper.

A scanner unit 106 optically reads an image on paper and converts the read image into an electrical signal to generate a scanned image.

A facsimile (FAX) 107 is connected to a public line 110 to perform facsimile communication with an external device.

A hard disk drive (HDD) 108 stores the program to be executed by the main CPU 101, and is used as a spool area for a print job, a scan job, and the like. The HDD 108 is further used as an area for storing and reusing a scanned image.

A signal bus 109 connects respective modules so that the modules communicate with each other.

The public line 110 connects the FAX 107 with an external device.

An image processing unit 111 executes conversion processing for converting a print job received via the network I/F 104 into an image suitable to be printed by the printer unit 105, and executes noise removal processing, color space conversion processing, rotation processing, compression processing, and the like on a scanned image read by the scanner unit 106. The image processing unit 111 executes image processing on the scanned image stored in the HDD 108.

A first flash read only memory (ROM) 120 and a second flash ROM 121 store programs including firmware (FW) to be executed by the main CPU 101. The first and second flash ROMs 120 and 121 further store default setting values of the image forming apparatus 1. Here, the second flash ROM 121 is used for backup. In a case where the first flash ROM 120 is tampered, a sub CPU 115 reads the FW from the second flash ROM 121 and performs recovery by overwriting the first flash ROM 120. For this reason, the second flash ROM 121 is protected against overwriting.

A serial peripheral interface (SPI) bus 114 connects the main CPU 101, the first flash ROM 120, the second flash ROM 121, and the sub CPU 115 with each other.

At activation of the image forming apparatus 1, the sub CPU 115 reads a main CPU FW 401 from the first flash ROM 120 before the main CPU 101 is activated, and verifies whether tampering occurs. As a tampering verification method, for example, public key information (value obtained by encrypting a Hash value using a public key) about digital signature of the main CPU FW 401 is stored in a one-time programmable (OTP) memory area 304 in the sub CPU 115 at the manufacturing time. The read main CPU FW 401 is decoded using the public key information to be verified. Examples of a public key encryption method include RSA-2048 and Elliptic Curve Digital Signature Algorithm (ECDSA).

A main CPU reset signal 117 is output from a power supply control unit 118 and is connected to a reset terminal of the main CPU 101.

The power supply control unit 118 controls a first power supply unit 180 and a second power supply unit 181. The power supply control unit 118 further controls reset of the sub CPU 115 and main CPU 101.

A sub CPU reset signal 152 is a signal for resetting the sub CPU 115.

A verification end signal 150 is a signal for notifying the power supply control unit 118 that the sub CPU 115 terminates the tampering verification (validity verification) in the first flash ROM 120. The verification end signal 150 is connected to the power supply control unit 118.

A recovery notification signal 151 indicates that the sub CPU 115 is recovering the first flash ROM 120 in a case where the first flash ROM 120 is tampered. The recovery notification signal 151 is connected to the power supply control unit 118.

A clock unit 170 provides a time function to the image forming apparatus 1 in such a manner that time information is given to an executed job in accordance with an operation of the image forming apparatus 1 as the information processing apparatus.

The image forming apparatus 1 can be brought into a plurality of power states including a first power state where power consumption is high and a sleep state where power consumption is lower than that in the first power state.

The first power supply unit 180 supplies power to a specific module of the image forming apparatus 1 in both of a case where the image forming apparatus 1 is in the first power state and a case where the image forming apparatus 1 is in the sleep state.

The second power supply unit 181 supplies power to a specific module only in the case where the image forming apparatus 1 is in the first power state. The second power supply unit 181 does not supply power to a specific module in the case where the image forming apparatus 1 is in the sleep state.

FIG. 1B illustrates the state of the image forming apparatus 1 in the sleep state. FIG. 1B illustrates a state where grayed-out modules are powered off. The modules in the powered-off state are the sub CPU 115, the second flash ROM 121, the second power supply unit 181, the operation unit 103, the image processing unit 111, the printer unit 105, the scanner unit 106, and the HDD 108.

### Configuration of Main CPU

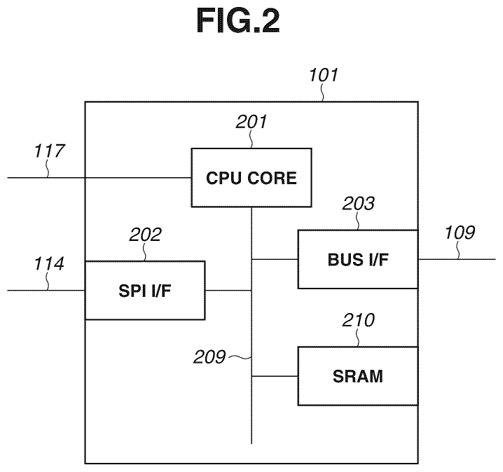

FIG. 2 illustrates a configuration of the main CPU 101.

A CPU core 201 provides a basic function of the CPU.

An SPI I/F 202 is connected to an external SPI device and configured to read and write data.

A signal bus 209 connects respective modules in the main CPU 101.

A static random access memory (SRAM) 210 is used as a work memory.

In a case where the main CPU reset signal 117 is in a “Low” level, the main CPU 101 is brought into a reset state. In a case where the main CPU reset signal 117 is in a “High” level, the main CPU 101 is brought into a reset release state. When the main CPU reset signal 117 makes transition from the reset state to the reset release state, the CPU core 201 first loads the main CPU FW 401 stored in the first flash ROM 120 into the SRAM 210 to execute the main CPU FW 401.

A bus I/F 203 is an interface for communication between the main CPU 101 and another module via the signal bus 109.

### Configuration of Sub CPU

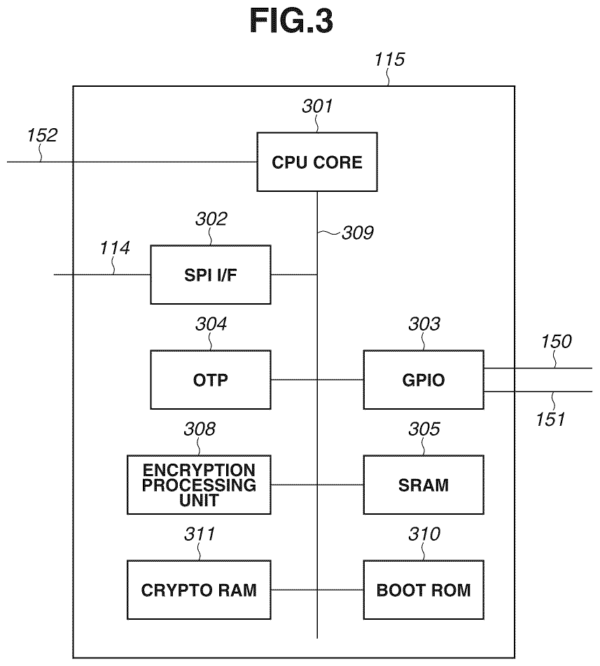

FIG. 3 illustrates a configuration of the sub CPU 115.

A CPU core 301 provides a basic function of the CPU.

An SPI I/F 302 is connected to an external SPI device and configured to read and write data.

A general-purpose input/output (GPIO) 303 is connected with an external device and configured to transmit and receive data.

A value obtained by encrypting a Hash value of the sub CPU FW using a public key and an address of Tag at manufacturing are to be written into the OTP memory area 304. If data is once written into the OTP memory area 304, the data cannot be rewritten again.

An SRAM 305 is used as a work memory in the sub CPU 115.

An encryption processing unit 308 decodes the Hash value of the sub CPU FW from the value encrypted with the public key, and decodes the Hash value of the main CPU FW encrypted with the public key.

A signal bus 309 connects the respective modules in the sub CPU 115. A boot read only memory (ROM) 310 stores a boot program of the sub CPU 115.

In a case where the sub CPU reset signal 152 is in the “Low” level, the sub CPU 115 is brought into the reset state. In a case where the sub CPU reset signal 152 is in the “High” level, the sub CPU 115 is brought into the reset release state. When the sub CPU reset signal 152 makes transition from the reset state to the reset release state, the CPU core 301 first reads a self-boot program from the boot ROM 310 and executes the program. A crypto RAM 311 stores confidential data or the like to be used by the encryption processing unit 308.

### Memory Map of Flash ROM

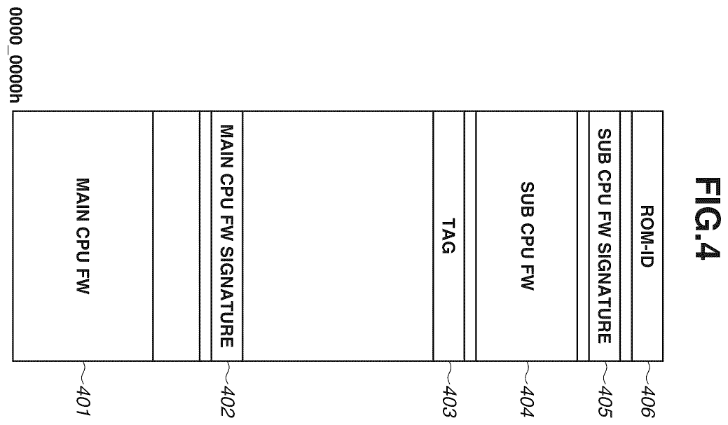

FIG. 4 illustrates a memory map of the flash ROMs 120 and 121.

In FIG. 4, a code to be executed by the main CPU 101 is stored in the main CPU FW 401.

A main CPU FW signature area 402 is an area for storing a value of an FW signature. An RSA signature value for the Hash value of the main CPU FW is stored in the main CPU FW signature area 402.

A head address of a sub CPU FW 404 is stored in a Tag 403. An address of the Tag 403 is stored in the OTP memory area 304.

A code to be executed by the sub CPU 115 is stored in the sub CPU FW 404.

An ECDSA signature value of the sub CPU FW 404 or an ECDSA signature value of a specific portion at the head of the sub CPU FW 404 is stored in a sub CPU FW signature 405.

A head address and size of the main CPU FW 401, and an address of the sub CPU FW signature 405 are stored in a ROM identification (ROM-ID) 406.

The first flash ROM 120 and the second flash ROM 121 each have a write-protect function such that data cannot be rewritten. By setting the write protection in an OTP register area, data after an address specified by a register can be protected.

### Power Supply Configuration of Image Forming Apparatus

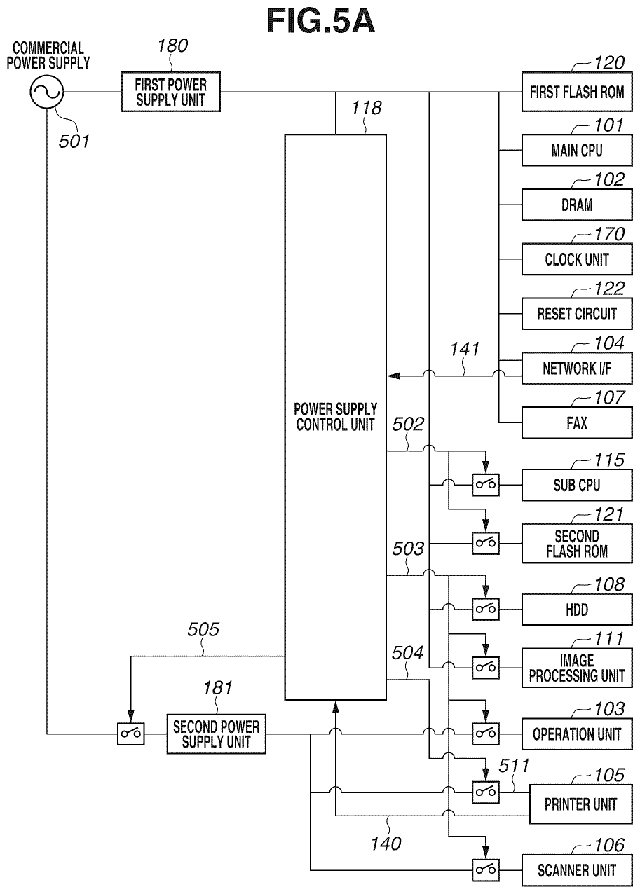

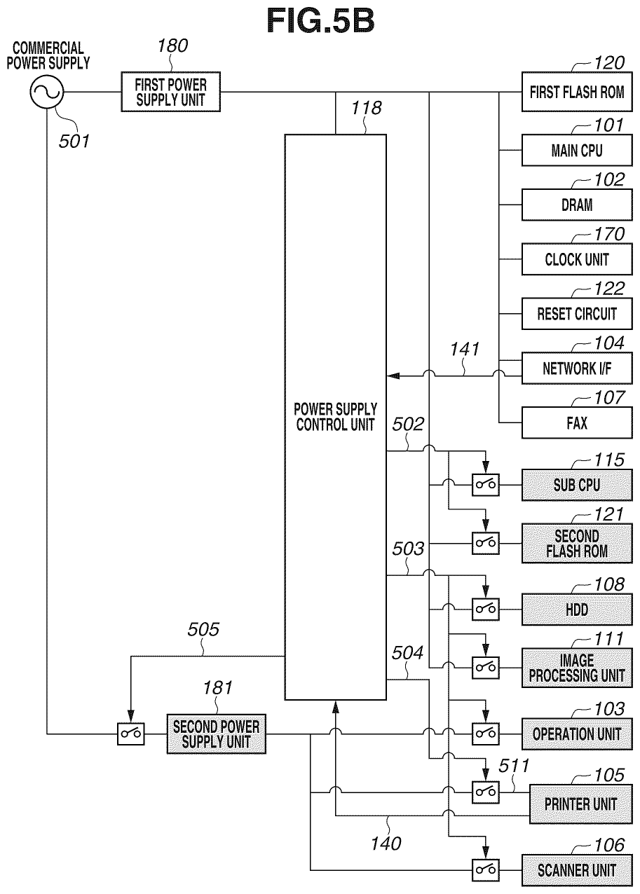

FIG. 5A illustrates a power supply configuration of the image forming apparatus 1 as the information processing apparatus.

Power is supplied from a commercial power supply input 501 to the respective modules of the image forming apparatus 1 via the first power supply unit 180 and the second power supply unit 181. Signals 502, 503, 504, and 505 output from the power supply control unit 118 turns off or on a field effect transistor switch (FET SW) on a line of the power supply supplied to the modules of the image forming apparatus 1 so as to control the power supply. The signal 502 is described as an example. When the signal 502 is “High”, the FET SW is turned on, and power is supplied to the sub CPU 115 and the second flash ROM 121. When the signal 502 is “Low”, the FET SW is turned off, and power is not supplied to the sub CPU 115 and the second flash ROM 121. The signal 502 is controlled by the power supply control unit 118. The other signals 503 to 504 are also controlled by the power supply control unit 118 in the same manner as the signal 502 as described above.

A power supply line 511 is used for supplying power to the printer unit 105. A notification signal 140 is an interruption signal from the printer unit 105, and is connected to the power supply control unit 118. Power supply to the printer unit 105 is controlled in accordance with the notification signal 140 being “High” or “Low”. A wake signal 141 is a wake signal to be output from the network I/F 104.

FIG. 5B illustrates a state of the image forming apparatus 1 in the sleep state. FIG. 5B illustrates a state where grayed-out modules are in a power-off state. Specifically, the sub CPU 115, the second flash ROM 121, the HDD 108, the image processing unit 111, the operation unit 103, the printer unit 105, the scanner unit 106, and the second power supply unit 181 are in a power-off state.

### Printer Unit

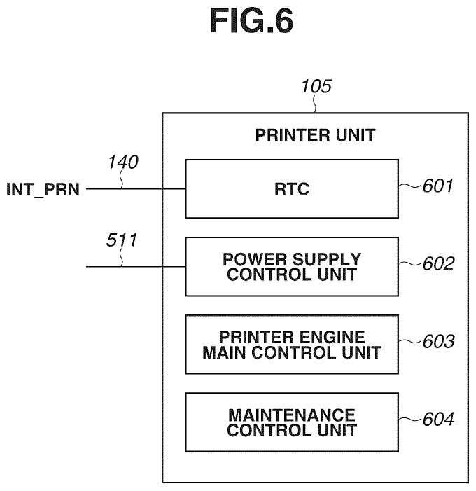

FIG. 6 illustrates a configuration of the printer unit 105.

A real time clock (RTC) 601 counts a current time, and outputs the notification signal 140 of “INT PRN” interruption from the printer unit 105 to the power supply control unit 118.

A power supply control unit 602 manages the power supply of the printer unit 105.

A printer engine main control unit 603 controls a printer engine.

A maintenance control unit 604 executes maintenance processing for maintaining image quality of the engine.

### Maintenance Processing

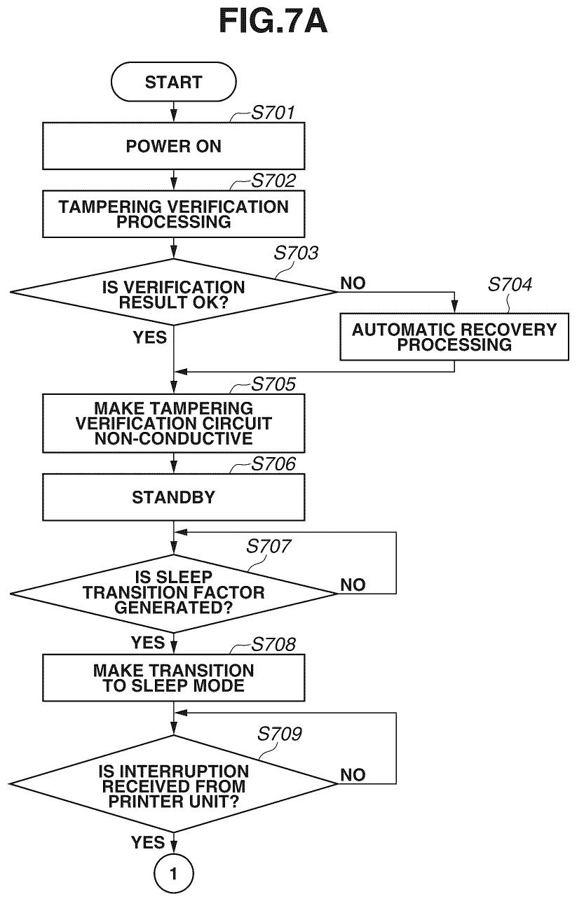

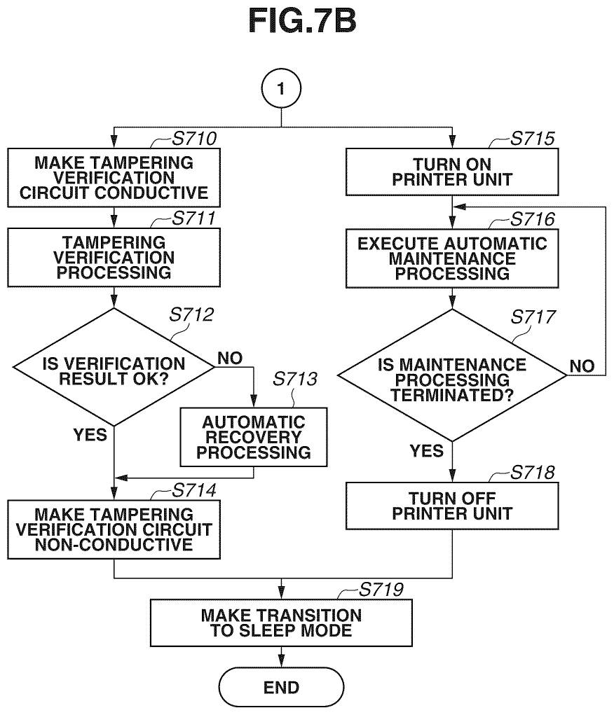

FIGS. 7A and 7B are flowcharts illustrating the maintenance processing of the printer unit 105 in the sleep state. The operations of the modules illustrated in FIG. 6 are described together with the maintenance processing in the flowcharts.

In step S701, a main power supply switch, which is not illustrated, of the image forming apparatus 1 is turned on by a user.

In step S702, before the main CPU 101 loads data of the first flash ROM 120, the sub CPU 115 verifies tampering in the first flash ROM 120.

In step S703, the sub CPU 115 determines whether a verified result is okay (OK) or no good (NG). In a case where the verified result is OK (Yes in step S703), the processing proceeds to step S705. In a case where the verified result is NG in step S703 (No in step S703), the processing proceeds to step S704.

In step S704, the sub CPU 115 reads the FW from the second flash ROM 121 for backup, and performs overwriting in the first flash ROM 120 to perform recovery.

The sub CPU 115 that performs the tampering verification in step S705 and the second flash ROM 121 are turned off for energy savings.

In step S706, the main CPU 101 brings the image forming apparatus 1 into a standby state.

In step S707, the main CPU 101 determines whether a sleep transition factor of the image forming apparatus 1 is generated. In a case where the main CPU 101 determines that the sleep transition factor is not generated (No in step S707), the image forming apparatus 1 stands by in step S707. In a case where the main CPU 101 determines that the sleep transition factor is generated (Yes in step S707), the processing proceeds to step S708.

In step S708, the main CPU 101 transitions the image forming apparatus 1 to a sleep mode.

The printer unit 105 needs to cause the maintenance control unit 604 to adjust image quality of the engine at a regular time interval. If a timer interruption occurs, the RTC 601 in the printer unit 105 transmits the notification signal 140 to the power supply control unit 118.

In step S709, the image forming apparatus 1 stands by until the notification signal 140 of the interruption is received from the printer unit 105. In step S709, when the notification signal 140 of the interruption is received, the main CPU 101 returns the image forming apparatus 1 from the sleep mode that is an energy saving mode, and executes processing in steps S715 to S718 and processing in steps S710 to S714 in parallel (steps S715 to S718).

In step S715, the power supply control unit 118 turns on the RMT_PRN signal 504 to make the printer unit 105 conductive.

In step S716, the maintenance control unit 604 in the printer unit 105 temporarily drives a mechanical unit such as a paper transportation unit, an intermediate image transfer belt, a toner fixing device, and the like, which are not illustrated, in the image forming apparatus 1. The maintenance control unit 604 then executes the maintenance processing so that inconsistency in a print image does not occur.

In step S717, it is determined whether the maintenance processing is terminated, and in a case where it is determined that the processing is terminated (Yes in step S717), the processing proceeds to step S718. In a case where it is determined that the processing is not terminated (No in step S717), the processing returns to step S716 to wait for termination.

When the processing is terminated in step S718, the power supply control unit 118 turns off the RMT_PRN signal 504 to make the printer unit 105 non-conductive (steps S711 to S714).

In steps S710 to S713, the sub CPU 115 executes the tampering verification processing (steps S702 to S705) that is similar to the processing executed at the power supply activation. When the verification processing is terminated, in step S714, the sub CPU 115 and the second flash ROM 121 are turned off.

When the processing in steps S714 and S718 is terminated, in step S719, the main CPU 101 transitions the image forming apparatus 1 to the sleep mode again.

### Timing Chart

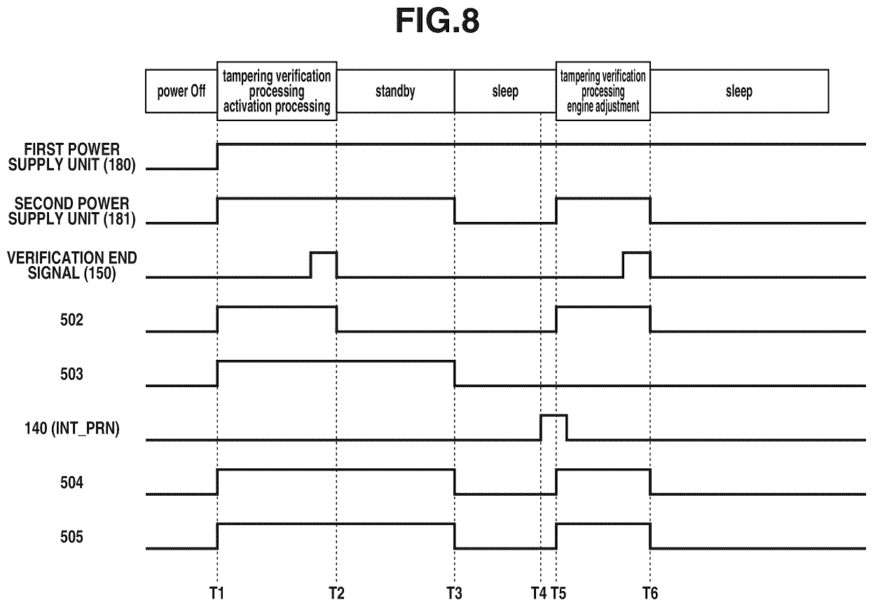

FIG. 8 is a timing chart illustrating the power supply state of the image forming apparatus 1 in a case where the processing in FIG. 7 is executed. A correspondence relationship between respective time stamps and the steps in FIGS. 7A and 7B is described below. Timing T1 corresponds to step S701 at power-on, and timing T2 corresponds to steps S705 and S706. Timing T3 corresponds to step S708, timing T4 corresponds to step S709, timing T5 corresponds to steps S710 and S715, and timing T6 corresponds to step S719.

T1: In step S701, a user turns on the power supply switch. As a result, the first power supply unit 180 and the second power supply unit 181 are in a “High” state, and power is supplied also to the power supply control unit 118. Thus, the signals 502, 504, and 505 become “High”.

The tampering verification processing (and automatic recovery processing) in steps S702 to S704 is executed. When the tampering verification processing is terminated, the sub CPU 115 notifies the power supply control unit 118 that the verification end signal 150 is “High”.

T2: The power supply control unit 118 detects that the verification end signal 150 becomes “High”, and sets the signal 502 to “Low” to turn off the sub CPU 115 and the second flash ROM 121.

T3: When a sleep factor is generated, the main CPU 101 transitions the image forming apparatus 1 to the sleep mode in step S708. The power supply control unit 118 sets the signals 503, 504, and 505 “Low” to turn off the HDD 108, the image processing unit 111, the operation unit 103, the printer unit 105, and the second power supply unit 181.

T4: In step S709, the power supply control unit 118 receives the notification signal 140 of an interruption from the printer unit 105.

T5: In steps S710 and S715, the CPU 101 instructs the power supply control unit 118 to turn on the sub CPU 115 that executes the tampering verification processing, the second flash ROM 121, and the printer unit 105. The power supply control unit 118 sets the signals 502, 504, and 505 “High” to turn on the sub CPU 115, the second flash ROM 121, the operation unit 103, the printer unit 105, and the second power supply unit 181.

T6: In step S719, the CPU 101 detects that the verification end signal 150 becomes “High”, and instructs the power supply control unit 118 to transition the image forming apparatus 1 to the sleep mode. The power supply control unit 118 sets the signals 502, 504, and 505 “Low” to turn off the sub CPU 115, the second flash ROM 121, the operation unit 103, the printer unit 105, and the second power supply unit 181.

In the first exemplary embodiment, the case is described where the tampering verification processing is executed in a case where an interruption of maintenance such as image quality adjustment occurs in the printer unit 105. In a second exemplary embodiment, a case will be described where a specific packet is received from the network I/F 104 during the sleep state and the tampering verification processing is executed.

### Configuration of Network I/F

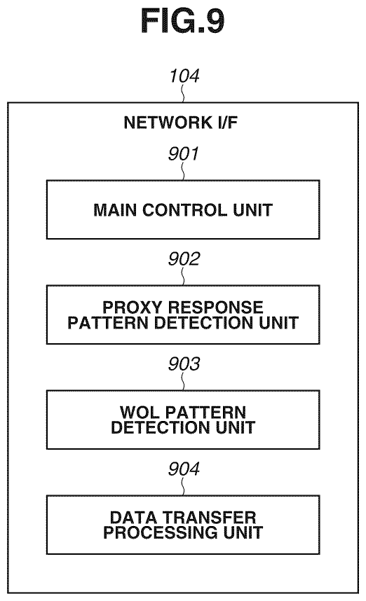

FIG. 9 illustrates an internal configuration of the network I/F 104.

A main control unit 901 controls the network I/F 104 in an overall manner.

A proxy response pattern detection unit 902 is a detection unit that recognizes a pattern of a packet to which a proxy response can be made when the main control unit 901 is in the sleep state among packets transmitted from a print server, which is not illustrated in FIGS. 1A and 1B, via the LAN 130.

A Wake-On-Lan (WOL) pattern detection unit 903 is a detection unit for a data pattern of a WOL packet. The WOL packet is neither a job packet nor a packet to which a proxy response can be made. The WOL packet includes, for example, an inquiry about the state of the image forming apparatus 1.

A data transfer processing unit 904 transfers data received from the LAN 130 to the DRAM 102 or transmits data in the DRAM 102 to the LAN 130 in response to the instruction from the main CPU 101.

### Tampering Verification Processing

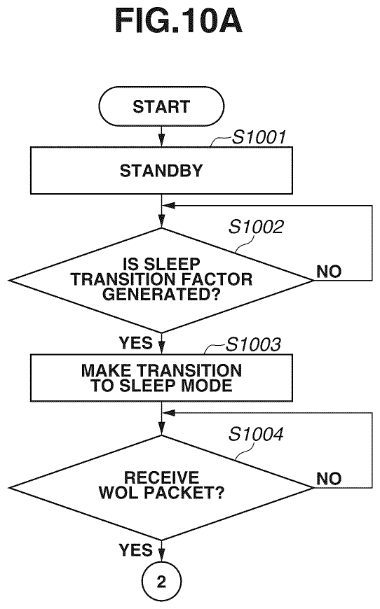

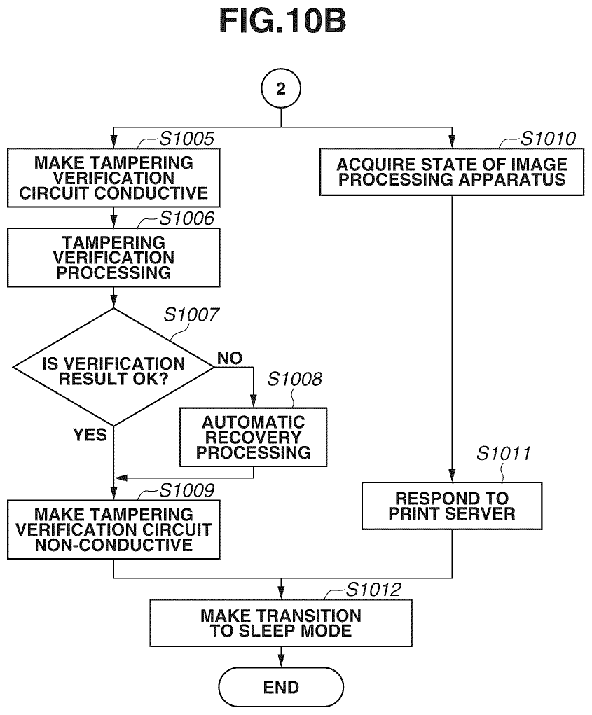

FIGS. 10A and 10B illustrate processing in a case where the tampering verification is performed when the network I/F 104 receives the WOL packet in the sleep state. The operations of the modules in FIG. 9 are described together with the processing.

Since the transition from the standby state in step S1001 to the sleep mode in step S1003 is similar to the contents described in the first exemplary embodiment, description thereof is omitted.

The WOL pattern detection unit 903 determines whether the contents of the packet received in step S1004 match the WOL pattern. In a case where the WOL pattern detection unit 903 determines that the contents of the packet received in step S1004 match the WOL pattern, the network I/F 104 notifies the power supply control unit 118 of the determination result by changing the wake signal 141 from “low” to “High”.

The processing in steps S1005 to S1009 and the processing in steps S1010 to S1011 are executed in parallel (steps S1005 to S1009).

The power supply control unit 118 detects that the wake signal 141 is “High”. In step S1005, the control signal 502 is changed from “Low” to “High” to turn on the FET SW and supply power to the sub CPU 115 that executes the tampering verification processing and the second flash ROM 121.

The tempering verification processing in step S1006 and thereafter is similar to the processing contents in steps S711 to S714 described with reference to the flowcharts of FIGS. 7A and 7B in the first exemplary embodiment (steps S1010 to S1011).

In parallel with the above processing, the main CPU 101 acquires the state of the image forming apparatus 1 in step S1010.

In step S1011, the main CPU 101 transmits a status response to the print server not illustrated.

When the processing in steps S1009 and S1011 is terminated, the image forming apparatus 1 again makes transition to the sleep mode in step S1012.

### Timing Chart

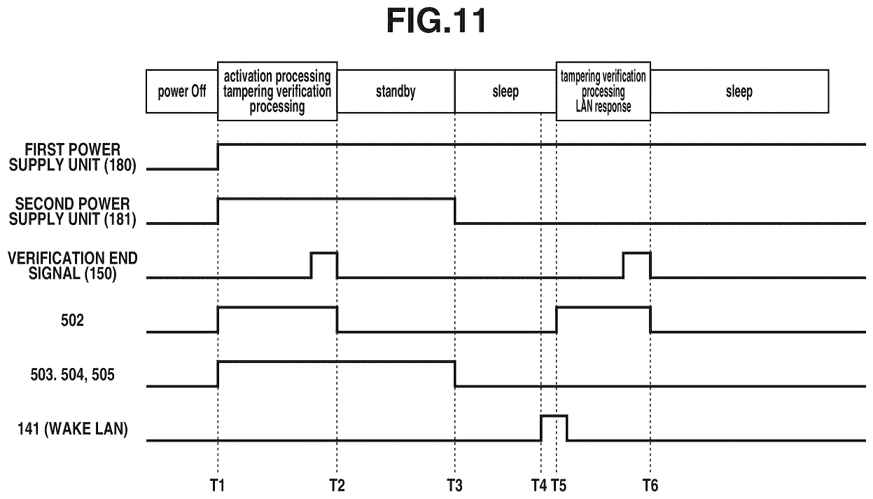

FIG. 11 is a timing chart illustrating the power supply state of the image forming apparatus 1 during the processing of the flowcharts in FIGS. 10A and 10B. Time stamps correspond to steps in the flowcharts of FIGS. 10A and 10B as follows. Timing T2 corresponds to step S1002, timing T3 to step S1003, timing T4 corresponds to step S1004, timing T5 corresponds to steps S1005 and S1010, and timing T6 corresponds to step S1012.

Explanation of the timings T1 to T3 that is similar to that in FIG. 8 is omitted.

T4: In step S1004, the power supply control unit 118 receives the wake signal 141 of an interruption about reception of a WOL packet from the network I/F 104.

T5: In step S1005, the CPU 101 instructs the power supply control unit 118 to turn on the sub CPU 115 that executes the tampering verification processing and the second flash ROM 121. The power supply control unit 118 sets the signal 502 “High” to turn on the sub CPU 115 and the second flash ROM 121.

T6: In step S1012, the CPU 101 detects that the verification end signal 150 becomes “High”, and instructs the power supply control unit 118 to transition the image forming apparatus 1 to the sleep mode. The power supply control unit 118 sets the signal 502 “Low” to turn off the sub CPU 115 and the second flash ROM 121.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2022-079312, filed May 13, 2022, which is hereby incorporated by reference herein in its entirety.

What is claimed is:

1. An information processing apparatus including a first storage unit storing a program and a second storage unit storing a backup program of the program, the information processing apparatus comprising:
a verification unit configured to verify tampering of the program stored in the first storage unit;
a recovery unit configured to perform recovery by overwriting the backup program stored in the second storage unit with the program stored in the first storage unit in a case where the program is tampered as a result of verification by the verification unit; and
a power control unit configured to stop power to the verification unit and the second storage unit upon termination of the verification by the verification unit in a case where the program is not tampered, and stop power to the verification unit and the second storage unit upon termination of the verification by the verification unit and termination of the recovery by the recovery unit in a case where the program is tampered.

2. The information processing apparatus according to claim 1, wherein the verification unit verifies tampering of the program stored in the first storage unit at activation.

3. The information processing apparatus according to claim 1, wherein the program is a boot program.

4. The information processing apparatus according to claim 1, further comprising:
an operation unit configured to accept an operation from a user,
wherein the power control unit transitions the information processing apparatus to a first power state where power is supplied to the operation unit and power is not supplied to the verification unit, and to a second power state where power consumption is lower than power consumption in the first power state and power is not supplied to the operation unit and the verification unit, and
wherein the power control unit transitions the information processing apparatus to the second power state in a case where a predetermined condition is satisfied when the information processing apparatus is in the first power state.

5. The information processing apparatus according to claim 4, further comprising:
an acceptance unit configured to accept an interruption signal in the second power state; and
an interruption processing execution unit configured to execute interruption processing based on the interruption signal,
wherein the power control unit transitions the information processing apparatus from the second power state to a third power state where power is supplied to the operation unit and the verification unit upon detection of the interruption signal, and
wherein the verification unit verifies the tampering of the program stored in the first storage unit in a case where the information processing apparatus is transitioned to the third power state.

6. The information processing apparatus according to claim 5, wherein the interruption processing is executed in parallel with the verification of the program performed by the verification unit.

7. The information processing apparatus according to claim 5, wherein the interruption processing includes maintenance processing based on an interruption signal at a regular time interval counted by a timer.

8. The information processing apparatus according to claim 5, wherein the interruption processing is processing for notifying a server connected via a network of a state of the information processing apparatus in response to a specific packet received from the server.
